(19) United States
(12) Patent Application Publication
(10) Pub. No.: US 2013/0230658 A1
(43) Pub. Date: Sep. 5, 2013

(54) IMPREGNATING DOSING DEVICE

(71) Applicant: FILMOP S.R.L., Villa del Conte (IT)

(72) Inventor: Zorzo Bruno, Villa del Conte (IT)

(73) Assignee: FILMOP S.R.L., Villa del Conte (IT)

(21) Appl. No.: 13/781,751

(22) Filed: Mar. 1, 2013

(30) Foreign Application Priority Data
Mar. 2, 2012 (IT) PD2012A000059

(51) Int. Cl. B05C 3/09

(52) U.S. Cl. CPC B05C 3/09
USPC 427/443.2; 118/429

(57) ABSTRACT

This is a device for impregnating a cleaning cloth, making available on a basin a pre-fixed amount of impregnation liquid, after having extracted it from a bucket by means of a pump.

### CROSS-REFERENCE TO RELATED APPLICATIONS

This application claims the benefit of Italian Patent Application PD2012A000059, filed on Mar. 2, 2012, and incorporated herein by reference.

### STATEMENT REGARDING FEDERALLY SPONSORED RESEARCH AND DEVELOPMENT

Not Applicable.

### FIELD OF THE INVENTION

This invention concerns cleaning equipment, and more particularly a device for impregnating and dosing a cleaning cloth with a fluid.

### DISCUSSION OF RELATED ART

A common experience is wet cleaning with a floor mop with relative cloth. Equally well-known is the need for this cloth to be moistened. Not equally practiced is the use of the detergent only in the necessary quantities.

Indeed, the correct concentration of detergent in the solution should be precise so that the cleaning can be carried out correctly. If the operator, even a professional one, has arrived at these above-mentioned conditions, on the basis of work experience, compliance with the conditions starts to be more specific and demanding when the composition of the cloth changes.

Indeed, recently there is widespread use of microfiber as the preferred cleaning cloth, because of its mechanical removal of the dirt, and also because of its properties of retaining the dirt once it has been removed. Now these cloths have the quality of being able to retain an amount of solution, more than experience recommends. Indeed, even small additional components of microfiber in the configuration of a normal cloth considerably increases its absorption capacity, nevertheless it takes quite a long time for the same microfiber cloth, because of its osmotic capillary nature, to absorb all the liquid and to become fully soaked.

We should bear in mind that also the professional operator has a hard time in finding the right solution to use with these cloths, and also in finding the right amount of liquid to use to correctly moisten the cloth. Indeed, too much liquid, even if at first sight it might seem like the right amount, runs the risk of releasing too much solution on the surface to be cleaned in the initial stages, with consequent poor results. Moreover, lately more attention has been placed on the use of very effective chemical concentrates, but which are equally harmful when they evaporate.

These vapors are increasingly less tolerated by cleaners who are in daily contact with them, and they are also not allowed in certain settings requiring delicate cleaning. No matter how much effort has gone into limiting their use and to compartmentalize the various cleaning elements, no satisfactory results have been obtained. In fact, very often these devices are used by cleaning companies made up of a few people who have to work in various places, very often outside normal working hours, and who have to bring all their equipment with them.

Very often during the necessary moving around to get to the places to be cleaned, the cleaning devices force the operator to be very careful not to dirty and/or wet places with the unintentional release or splashes of the washing liquid, because the various devices are often lacking any sealing or partition that would prevent or limit said splashes of the washing liquid when moving from one place to another.

It is clear that when travelling by car the system should out of necessity be compartmentalized, so no vapors are released, in order to safeguard the occupants in an environment that is poorly ventilated, like for example the inside of a car. Another equally important requirement is transportability and practicality of use. In fact, the systems that allow for the pre-impregnation of a certain number of cloths, to be prepared generally the day before being used, is not practical at all, but on the contrary are almost always not suitable for requirements, either because of the over-estimation of the number of pre-impregnated cloths or with serious inconvenience if even just one cloth is lacking. Last but not least, there is the requirement that the system can also be independent of any electrical power supply.

### SUMMARY OF THE INVENTION

In this situation, the main purpose of this invention is to make available an impregnation device that can overcome one or more of the above-mentioned drawbacks. Another object of this invention is to make available a device that guarantees the proper impregnation of a cleaning cloth. An even further object of this invention is to make available an impregnation device that can adapt quickly to the cloths to be used for cleaning.

An even further object of this invention is to make available an impregnation device that can flexibly prepare the cloths to be used in the cleaning in the right number required by the circumstances, without having to waste time waiting for an additional cloth to be impregnated, and without leaving any already impregnated cloths unused. Another object of this invention is to make available an impregnation device that in practice does not exceed the dimensions of a normal cleaning bucket. An even further object of this invention is to make available an impregnation device that embodies in a single device a partitioning device, the impregnating device and the liquid detergent tank.

Preferably the above-mentioned device would be easy to transport even by hand, and fitted with a standard transportation handle. Another object of this invention is to make available an impregnation device that can be hermetically sealed, so that it does not release any vapors of the solution used and contained in the tank. A still further object of this invention is to make available an impregnation device that has devices to allow it to be shifted from one place to another without an inadvertent release of cleaning liquid, through the locking of the movement devices. Another object of this invention is to make available an impregnation device that can be used also without any electrical power. An even further object of this invention is to make available an impregnation device that can be easily released from a solution in the tank, for a replacement with another solution needed for cleaning requirements. Another object of this invention is to make available an impregnation device that that can work with liquid detergents and with thick and semi-thick detergents. Another object of this invention is to make available an impregnation device that can be easily and visually locked when working, thereby preventing the accidental release of the liquid during transportation or during storage. Another object of this invention is to make available an impregnation device that that is more practical and quicker than prior procedures for impregnating cleaning cloths.

These and other aims are all embodied in the impregnation device, as set out in the attached claims. All the above-mentioned characteristics are embodied in an impregnating device composed of a bucket to which is joined a pump that can transfer a limited amount of liquid in said bucket into a basin whose dimensions are compatible with those of a cloth outstretched for impregnation of said cloth with the amount of liquid transferred by the pump.

Therefore said bucket is composed of a bucket containing the washing solution, from whose bottom can be drawn using a pump, beneficially an alternate pump, a pre-set amount of solution is drawn and transferred onto a flat basin. Beneficially said flat basin is the cover or the top closing of said bucket on which the impregnation of the cloth is carried out with the correct amount of liquid needed for good cleaning. Another advantage of the system of the invention is making available an impregnation device that can easily adjust the amount of liquid or solution made available for impregnation. Another advantage of the above-mentioned ease of regulation is that it can be easily checked visually. Another advantage of the system is to make available an impregnation device where the device for drawing off the liquid is joined to and/or next to the basin in which the liquid taken from the tank is poured.

Advantageously, said pump is made as a body, preferably tubular, inside which slides a piston joined to an outer moving shaft. Conveniently, said piston inside said body establishes a first and a second volume, respectively above and below said piston, with all said volumes alternately filled and emptied of the desired amount of liquid following an action to draw the liquid in the bucket and cleared from the second to the first volume, with the amount of liquid poured from the second to the first volume, finally, transferred to the basin during a successive siphoning action. Said piston, in fact, which has one or more finned circumferential gaskets that expand in a vacuum to make an airtight seal, draws and then discharges into the basin at every stroke an amount of liquid in line with the regulation that was pre-set with the adjustment devices that are described below.

Constructively, the pump has an adjustment device to set the amount of liquid transferred to the basin in a regulated manner. Usefully, the adjustment device, which regulates the amount of liquid transferred to the basin by limiting the possible travel of the shaft stroke, is joined to the shaft of said piston that slides partially sealed inside said pump body.

Another advantage consists of the fact that said regulation device is composed of a sleeve that is coaxial to a tubular element fitted with a series of circumferential grooves suitable for being alternately engaged by a coupling element on the inner surface of said sleeve to make said sleeve take on a variable height, which acts as an end stop on a ring connected to the shaft and therefore limiting its travel, to reduce the capacity of said first volume, and therefore the amount of liquid poured into the basin. Another characteristic of the system of this invention is that it makes available an impregnation device where the tank, the drawing device or pump and the impregnating basin are one piece. Another advantage of the system of this invention is that it makes available an impregnation device that in addition to being one piece can be easily transported and does not exceed the dimensions of a normal cleaning bucket. Another useful aspect of the system of this invention is that it makes available an impregnation device that can be transported by hand using the standard transportation handle.

Another useful feature of the system of this invention is that it makes available an impregnation device that is sealed tight and does not release any vapors of the solution inside the tank. Another useful aspect of the system of this invention consists in giving the shaft of the pump of the piston a locking element for the shaft of the piston to prevent it accidentally operating, especially when it is shifted, preferably configured as a flange, resting against said sleeve, preferably on its top face, which is capable of taking on a stable position interfering with the shaft of the piston, preventing it from lifting, and another stable position rotated around its axis, with respect to the previous position, that provides for the free sliding inside the shaft of the piston.

Another advantageous aspect lies in the fact that the preparation of a cloth for cleaning is always done when required, starting with dry cloths and impregnating just before use only the cloths that are required, thereby avoiding the preparation by pre-impregnation of those cloths that will not be employed in cleaning. Beneficially, the system of this invention makes available an impregnation device that is operated without the need of any electrical power supply.

Another advantage of the system of this invention makes available an impregnation device that has a tap for discharging the solution in the bucket when required. The procedure making use of the impregnation device described above is characterized by the steps that will be highlighted below in the description of the operation of a possible construction.

### DESCRIPTION OF THE DRAWINGS

The technical characteristics of the invention, according to the above-mentioned purposes, can be clearly seen in the claims below and the benefits will be more clearly evident in the detailed description that follows, made with reference to the attached diagrams, which represent a form that is purely by way of example only and in no way restrictive, where:

FIG. 1 shows the a cross-section view of the impregnation device;

FIG. 2 shows a plane view from above of the impregnation device;

FIG. 3 and FIG. 4 show respectively a plane view and a prospective view of a diametric section of the pump during the suction phase;

FIG. 5 and FIG. 6 show respectively a plane view and a prospective view of a diametric section of the pump with the piston in the extreme lower position;

FIG. 7 and FIG. 8 show respectively a plane view and prospective view of a diametric section of the pump where the adjustment device prevents the piston from dropping any further;

FIG. 9 and FIG. 10 show respectively a prospective view and a prospective view of a diametric section of the pump where the operating handle is folded over to facilitate the transportation of the impregnation device.

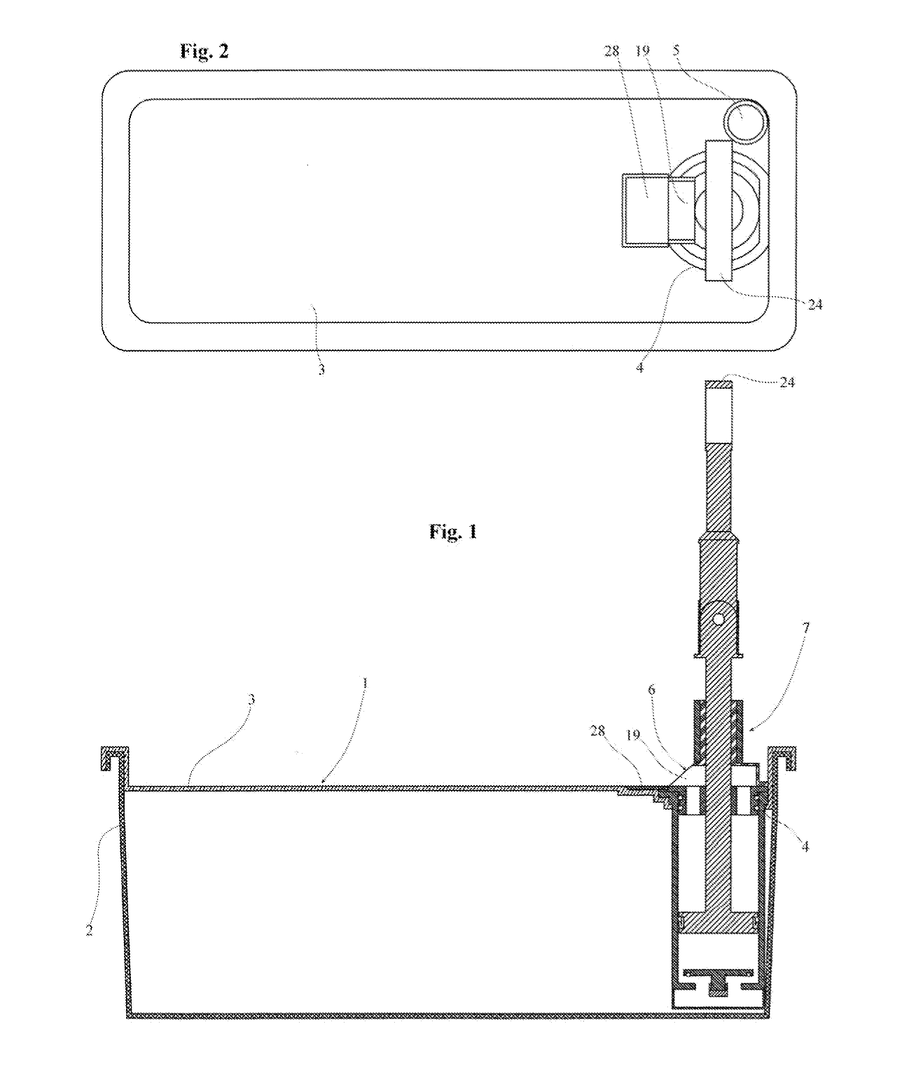

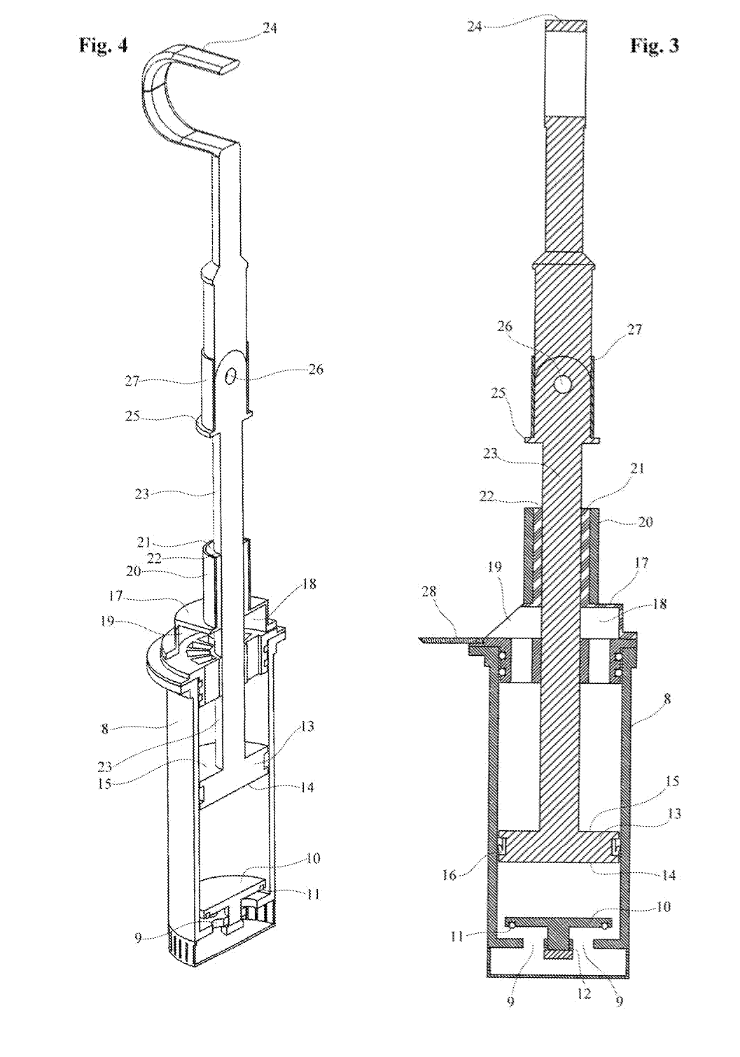

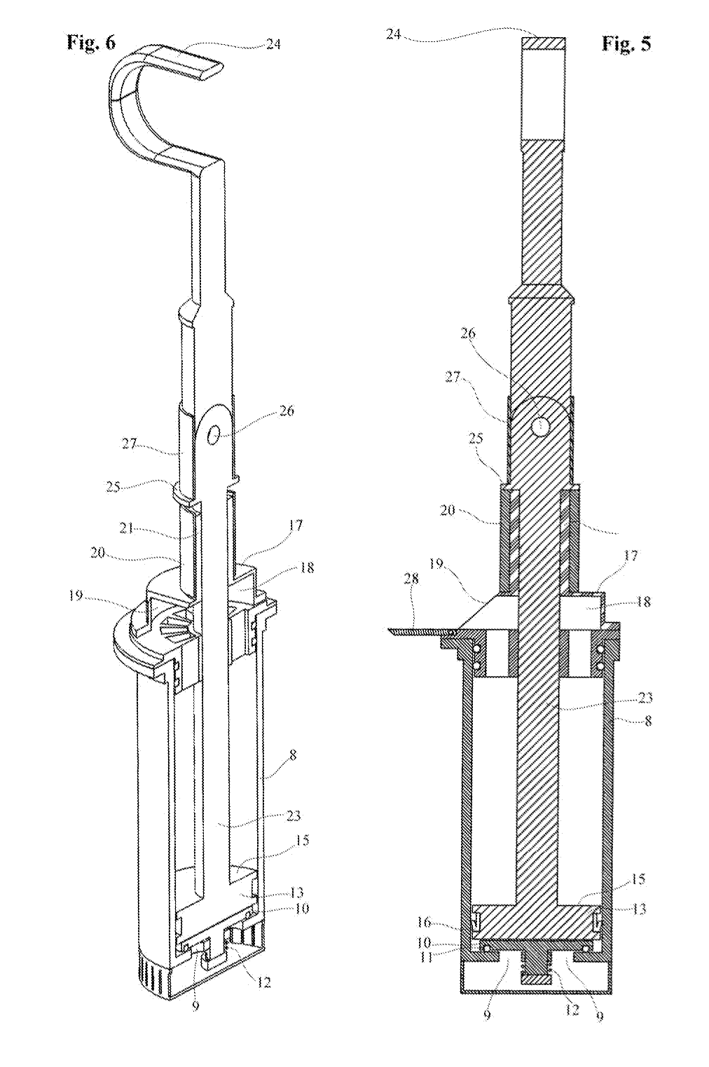

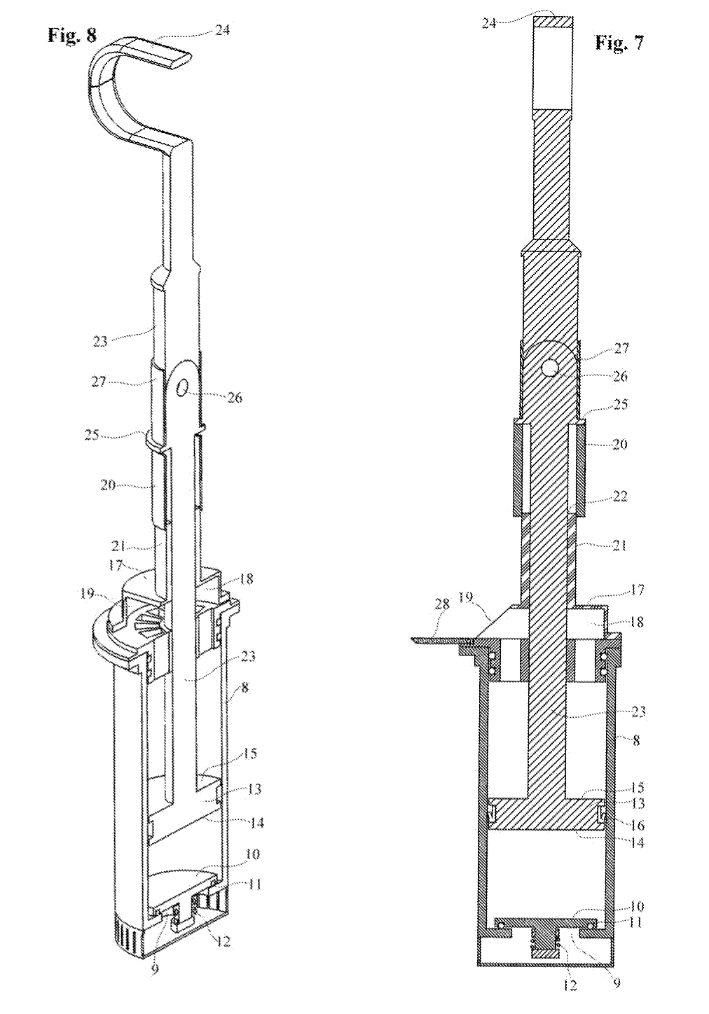

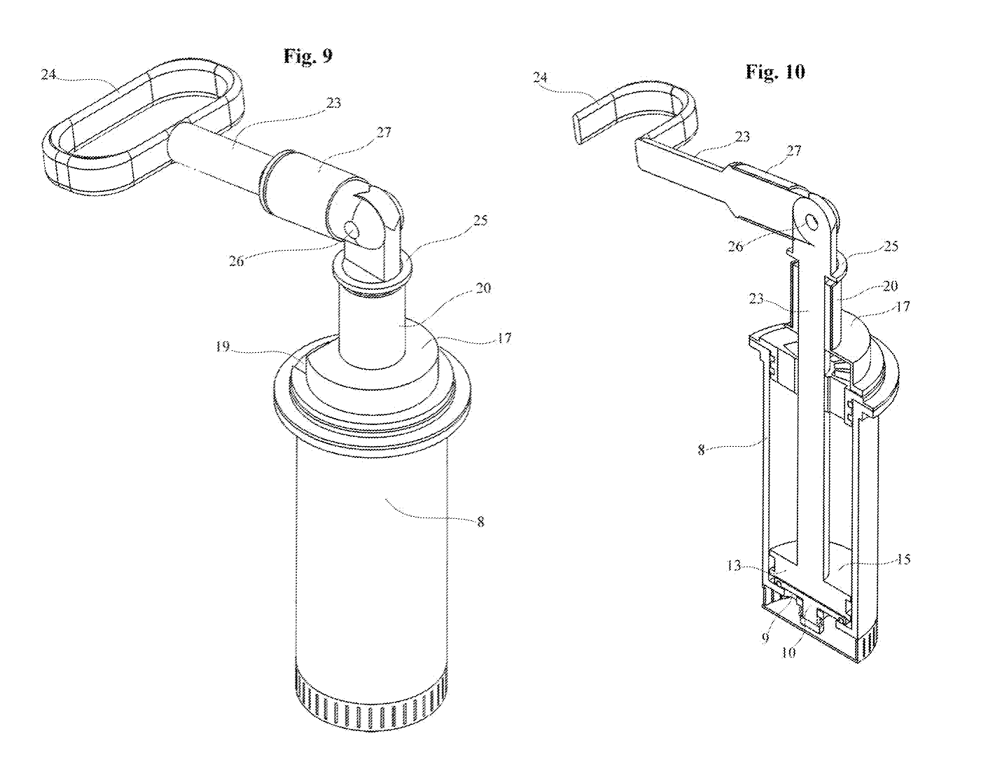

### DETAILED DESCRIPTION OF THE PREFERRED EMBODIMENT

The generic impregnation device, as set out in the diagrams, is configured as a bucket 1 and a pump 6 connected to it. The bucket 1 is composed of a container 2 containing the cleaning liquid, whose upper opening is hermetically sealed by a cover 3 that can be removed or closed in a fixed and watertight manner by a closing. Eventually the container 2 can have a tap for releasing the liquid, located near the bottom, to facilitate its emptying or for changing the liquid contained in it.

Said cover 3 or closing has an opening 4 through which goes a pump 6 for drawing off the washing solution to transfer the liquid into the cavity of the removal cover 3 above or fixed closing configured as a basin. Preferably said cover 3 has another opening 5 for the topping up or filling of the liquid to go inside the container 2. To allow only the desired amount of said liquid to be drawn and conferred inside the cover 3 configured as a basin, said pump 6 has a regulation device 7 suited to this purpose.

The pump 6 is configured as a body 8 preferably with a circular section with openings 9 near the lower part; said openings 9 are held closed by a restraint system 10 complete with gasket 11. During a rest condition, beneficially the restraint system 10 keeps, by means of elastic devices 12, said openings 9 near the bottom of the body 8 of the pump 6 closed.

Only after the suction realized by the siphoning movement inside the body 8 by a piston 13, does the depressurization created in the lower side 14 of the piston 13 overcomes the restraint system 10, drawing up the liquid in the bucket 1 to pass through the lower openings 9 and inside the body 8 of the pump 6.

This flow of liquid from the bucket 1 inside the body 8 of the pump 6 continues for the entire stroke of the piston 13 until the depressurization created by it allows the force of the elastic devices 12 of the restraint system 10, that keep closed the lower openings 9 in the body 8 of the pump 6, to be overcome.

Once the siphoning stroke has finished, a stroke in the opposite direction takes the liquid in the body 8 of the pump 6 from the delimited volume of the lower part 14 of the piston 13 to the volume inside the body 8 of the pump delimited by the top part 15 of the piston 13. In fact, the liquid inside the volume of the body 8 delimited by the lower part 14 of the piston 13 cannot flow through the lower openings 9 of the body 8 because they have been closed by the restraint system 10. The liquid being draw through the gasket 16, with which the piston is equipped circumferentially, gradually brings the piston 13 to move in the opposite direction to the suctioning, inside the volume of the body 8 delimited by the top part 15 of the piston 13.

A new suctioning movement of the piston 13, in addition to drawing more liquid inside the body 8 of the pump 6 in the volume delimited by the lower part 14 of the piston 13, allows you to empty the liquid in the volume of the body 8 of the pump 6 delimited by the top part 15 of the piston 13, which had been previously filled, pouring it inside the cover 3 configured as a basin. To prevent the liquid siphoned up from flowing in an uncontrolled manner, the top part of the pump 6 has a shell 17 open on the side that creates a collection chamber 18 with an opening 19 facing the cover 3 configured as a basin.

The adjustment of the amount of liquid that the pump needs to pour into the cover 3 configured as a basin, is carried out using an adjustment system 7 that limits the stroke of the piston 13, reducing the accumulation of liquid inside the body 8 of the pump 6 in the volume defined by the top part 15 of the piston 13.

It should be noted that this system functions in a calibrated manner, independently of the amount of liquid contained in the bucket 1, since the pump 6 draws from the bottom of the container 2 to the limit of the suction capacity and keeps always the same amount of liquid inside the pump 6 in the volume defined by the lower part 14 of the piston thanks to the restraint system. Beneficially, the regulation system 7 that limits the stroke of the piston 13 limiting the descent, with some steps, which correspond each one to ¼ o ⅕ of the entire capacity, helping the operator in selecting the liquid necessary to impregnate the cloth.

A simple example of the regulation system 7 that provides for regulation through the above-mentioned steps is shown in the diagrams, where a sleeve 20 joins in a coaxial and sliding manner to a grooved guide 21 formed of a series of overlapping grooves, inside at least one of which a coupling notch is inserted in the inside of said sleeve 20. Said grooved guide 21 has inside and always in a coaxial manner a hole 22 for the passage of the shaft 23 of the piston 13. The top end of the shaft 23 of the piston 13 is operated by a handle 24 that the operator grips.

In the middle on said shaft 23 there is a stop ring 25, which in association with said sleeve 20 of the regulation system 7, limits the travel of the piston 13. Shifting and putting the coupling element on the inner surface of said sleeve 20 inside one of the grooves of the grooved regulation guide 21, the descent movement of said shaft 23 of the piston 13 is limited by the coupling element of said ring 25 joined to the shaft 23 on said sleeve 20 of the regulation system 7. Beneficially, the connection of the operating handle 24 with the shaft 23 of the piston 13 is articulated, with a hinge 26 that allows the end part of the shaft 23, namely the one joined to the handle 24, to bend at least 90° with respect to the axis of the shaft 23 joined to the piston 13.

During the operation of the piston 13, another sleeve 27 splined to the shaft 23 in a coaxial manner, is arranged in a sliding manner on the hinging 26 of the end section of the shaft 23, making it continuous and without deflections, for the operations of alternate action, like the lifting, suction, recovery of the solution inside the body 8 of the pump 6. With this possibility of bending the end of the shaft 23 of the piston 13 the height of the impregnation device is limited, and above all this allows a standard transport handle of the bucket 1 to be used, hinged along the longitudinal axis of the bucket 1, which can remain turned on one side of the bucket 1 during the operating phase, but during the transport phase can be raised above the pump 6 without any interference with the handle 24 joined to the shaft 23 of the piston 13.

To make transportation easier and to render the impregnation device airtight with no risk of vapor being released during transportation or during storage, it has a closure, preferably configured as a closing tab capable of sealing the aperture where the cleaning liquid comes out of the bucket, in particular the opening 19 of the shell 17 is closed by this closing tab 28, compartmentalizing the collection chamber 18 in an airtight manner. Beneficially, said closing tab, when open and resting inside a suitable footprint on the cover, is arranged under the surface of the basin of the cover 3, and so an active surface results that is available for the positioning of the cloth to be impregnated after said basin is flooded by the liquid drawn by the pump 6.

Another beneficial aspect allows the impregnation device to be transported, or to be stored when not being used, without there being any accidental movement of said moving shaft with a consequent uncontrolled pouring of the cleaning liquid in said bucket; this consists of a blocking of the movement of the shaft carried out by a flange on the top joined to the sleeve, which is capable of assuming at least two stable positions, a first one that interferes with the shaft of the piston impeding it from being raised, and a second stable position, rotated around its axis, with respect to the previous position, which allows the free sliding inside said flange of the shaft of the piston for normal operations.

The operation and use of the impregnation device described above is easy to understand. The operator, provided with a series of dry cloths, goes to the cleaning place and after activating the impregnation device, by removing any blocks that impede the accidental lifting maneuver of the handle and the pouring of the liquid, draws the necessary amount of liquid inside the basin and then lays out a first dry cloth.

After the necessary time for impregnation with all the liquid, the cloth is ready for use. Conveniently the preparation of a successive dry cloth is therefore carried out by the operator immediately after removing from the device the already impregnated cloth, and coming back after a period of cleaning to the device finds the cloth, previously laid out on the basin soaked in the liquid, and ready and impregnated without having to wait before carrying out the cleaning operations.

The invention designed and configured in this way therefore attains all the objectives. Obviously, it will assume, in its practical realization, also forms and configurations different to the one illustrated above without, for this reason, going outside the present ambit of protection. Moreover, all the details will have to be replaced by technically equivalent elements and the dimensions, forms and materials used will have to be fit the requirements.

What is claimed is:

1. An impregnation device comprising of a bucket with a cover, characterized by the fact that joined to said bucket is a pump that can transfer a limited amount of liquid in said bucket into a basin with edges whose dimensions are compatible with those of a cloth that is outstretched for the wetting of said cloth with the amount of liquid transferred by the pump.

2. The impregnation device according to claim 1 characterized by the fact that said pump is installed directly on the cover of said bucket.

3. The impregnation device according to claim 1 characterized by the fact that said cover is also the impregnation basin.

4. The impregnation device according to claim 1 characterized by the fact that said pump includes a body inside which slides a piston joined to an externally moving shaft, said piston establishing inside said body a first and a second volume, respectively above and below said piston, with said volumes alternately filled with and emptied of the desired amount of liquid following the suctioning off of the liquid in the bucket and siphoned off from the second to the first volume, where the amount of liquid siphoned off from the second to the first volume is finally transferred to the basin during a successive suctioning.

5. The impregnation device according to claim 1 characterized by the fact that the pump has a regulation device that adjusts the amount of liquid transferred to the basin.

6. The impregnation device according to claim 4 characterized by the fact that the pump has a regulation device that adjusts the amount of liquid transferred to the basin.

7. The impregnation device according to claim 5 characterized by the fact that said regulation device is composed of a sleeve coaxial to a tubular element fitted with a series of circumferential grooving suitable for being alternatingly engaged by a coupling element on the inner surface of said sleeve to allow said sleeve to assume a variable height, which acts as a stop on a ring on the shaft and therefore limiting its travel, in order to reduce the capacity of said first volume.

8. The impregnation device according to claim 6 characterized by the fact that said regulation device is composed of a sleeve coaxial to a tubular element fitted with a series of circumferential grooving suitable for being alternatingly engaged by a coupling element on the inner surface of said sleeve to allow said sleeve to assume a variable height, which acts as a stop on a ring on the shaft and therefore limiting its travel, in order to reduce the capacity of said first volume.

9. The impregnation device according to claim 1 characterized by the fact that said pump has a shaft and the end part of said shaft, to which a handle is attached, is hinged so as to be able to folded, thereby reducing the height of the impregnation device.

10. The impregnation device according to claim 4 characterized by the fact that an element for blocking the movement of the shaft of the piston configured as a flange on said sleeve is capable of assuming at least one first stable position that interferes with said shaft of the piston, impeding it from rising, and at least a second stable configuration, rotated around its axis, with respect to the first configuration that allows the shaft of the piston to slide freely inside it.

11. The impregnation device according to claims 1 characterized by the fact that the bucket and cover create a hermetic seal to prevent vapors being released during transportation or when stored, a closure being included that keeps sealed an aperture where the cleaning liquid comes out of the bucket.

12. A method for impregnating a cleaning cloth characterized by the following steps:
a. providing an impregnation device comprising of a bucket with a cover, characterized by the fact that joined to said bucket is a pump that can transfer a limited amount of liquid in said bucket into a basin with edges whose dimensions are compatible with those of a cloth that is outstretched for the wetting of said cloth with the amount of liquid transferred by the pump;
b. setting up the impregnation device;
c. moving the shaft to which the piston of the pump is solidly connected with suction of an amount of liquid from the bucket inside the body of the pump and the contemporaneous transferal of the liquid into the basin;
d. moving the shaft in the direction opposite to the previous movement to cause the siphoning of the liquid between the two inner volumes defined by the body of the pump and the piston;
e. stretching out of a dry cloth in said flooded basin;
f. removing the impregnated cloth that is ready to be used for cleaning from the basin;
g. repeating from step c), without having to adjust the regulation device, in order to impregnate cloths of the same type.
